(19) United States
(12) Patent Application Publication
(10) Pub. No.: US 2008/0211813 A1
(43) Pub. Date: Sep. 4, 2008

(54) Device and Method for Light and Shade Simulation in an Augmented-Reality System

(75) Inventors: Ankit Jamwal, Munchen (DE); Alexandra Musto, Munchen (DE); Reiner Muller, Peiting (DE); Günter Schrepfer, Taufkirchen (DE)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, Munchen (DE)

(21) Appl. No.: 11/665,358

(22) PCT Filed: Jul. 5, 2005
(86) PCT No.: PCT/EP05/53194

§ 371 Date: Jan. 9, 2008

(30) Foreign Application Priority Data
Oct. 13, 2004 (EP) 04024431.1

(51) Int. Cl. G06T 15/50; G01J 1/16

(52) U.S. Cl. 345/426; 345/633

(57) ABSTRACT

A device and a method guide light in an augmented-reality system, whereby a recorder unit, with an optical axis, records a real object and displays the same on a display unit. A data processing unit generates a virtual object and also displays the same on the display unit. Based on a known sensor positioning, a sensor alignment, a sensor directional diagram and a provided sensor output signal from at least two light-sensitive sensors, an illumination angle is then determined and the light guidance for the virtual object carried out in the display unit, based on said illumination angle.

### CROSS REFERENCE TO RELATED APPLICATION

The application is based on and hereby claims priority to PCT Application No. PCT/EP2005/053194 filed on Jul. 5, 2005 and European Application No. EP04024431 filed on Oct. 13, 2004, the contents of which are hereby incorporated by reference.

### BACKGROUND

A device and method for light guidance in an augmented reality system and generate virtual shadow and/or virtual fill-in regions for inserted virtual objects according to actual illumination conditions, which can be used for mobile terminals, such as mobile telephones or PDAs (personal digital assistants).

Augmented reality represents a new technological area, wherein additional visual information is for example overlaid on a current optical perception of the real environment. A basic distinction is made here between what is known as see-through technology, where a user for example looks into the real environment through a light-permeable display unit, and what is known as feed-through technology, where the real environment is recorded by a recording unit, such as a camera for example, and mixed or overlaid with a computer-generated virtual image before being shown on a display unit.

As a result a user therefore perceives both the real environment and the virtual image components, generated by computer graphics for example, as a combined representation (cumulative image). This mixing of real and virtual image components for augmented reality allows the user to execute their actions directly incorporating the overlaid and therefore simultaneously perceivable additional information.

So that an augmented reality is as realistic as possible, an important problem relates to determining the real illumination conditions, so that the virtual illumination conditions or what is known as light guidance are tailored optimally for the virtual object to be inserted. Such virtual light guidance or the tailoring of virtual illumination conditions to real illumination conditions relates below in particular to the insertion of virtual shadow and/or fill-in regions for the virtual object to be inserted.

Until now the realization of such virtual light guidance or integration of virtual shadow and/or fill-in regions in augmented reality systems was dealt with largely in a very static manner, with the position of a light source being integrated into the virtual 3D model in a fixed or unchangeable manner. The disadvantage of this is that changes in the position of the user or recording unit or light source, which also result directly in a change in the illumination conditions, cannot be taken into account.

With another known augmented reality system the illumination direction is measured dynamically by image processing, with an object of a particular shape, for example a shadow catcher, being positioned in the scene and the shadows this object casts on itself being measured using image processing methods. However this has the disadvantage that this object or shadow catcher is always visible in the image when changes occur in the illumination, which is not practical in particular for mobile augmented reality systems.

### SUMMARY

One possible object of the invention is therefore to create a device and method for light guidance in an augmented reality system, which is simple and user-friendly and can in particular be used for mobile areas of deployment.

The inventors propose using at least two light-sensitive sensors, each with a known sensor directivity pattern and having a known sensor positioning and sensor alignment in respect of the recording unit and its optical axis, it is possible for a data processing unit to determine an illumination angle in relation to the optical axis of the recording unit based on the known sensor positioning, the sensor alignment and the characteristics of the sensor directivity pattern as well as the detected sensor output signals. The light guidance or a virtual shadow and/or fill-in region for the virtual object can then be inserted in the display unit as a function of this illumination angle. It is thus possible to achieve very realistic light guidance for the virtual object with minimal outlay.

A one-dimensional illumination angle is preferably determined by establishing the relationship between two sensor output signals taking into account the sensor directivity pattern and the sensor alignment. Such a realization is very economical and also user-friendly, as the former markers or shadow catchers are no longer required.

A spatial illumination angle is preferably determined by triangulating two one-dimensional illumination angles. With such a method, as used for example in GPS (global positioning system) systems, three light-sensitive sensors suffice in principle, the alignment of said sensors not lying in a common plane. This further reduces the realization outlay.

A spatial illumination angle can further be estimated based on only one one-dimensional illumination angle as well as based on the time of day, it being possible, in particular with a daylight environment, also to take into account a respective position of the sun as a function of the time of day, in other words the vertical illumination angle. In some application instances it is therefore possible to reduce the realization outlay further. To determine the daylight environment a detection unit can for example be used to detect a color temperature of the illumination present and an analysis unit to analyze the color temperature, with the detection unit preferably being realized by the recording unit or camera that is present in any case.

For the purposes of optimizing accuracy and further simplification, the characteristics of the directivity patterns of the sensors are preferably the same and the distances between the sensors as large as possible.

The illumination angle is also determined continuously as a function of the recording unit in respect of a time axis, thereby allowing a particularly realistic light guidance to be generated for the virtual objects.

To improve accuracy further and to process difficult illumination conditions, the sensors with their sensor alignments and associated directivity patterns can preferably be disposed in a rotatable manner.

A threshold value decision unit can also be provided to determine a uniqueness of an illumination angle, with the virtual light guidance being disabled in the absence of uniqueness. Therefore no virtual shadow and/or fill-in regions are generated for the virtual object in particular in diffuse illumination conditions or illumination conditions with a plurality of light sources distributed in the space.

As far as the method is concerned, a real object is first recorded using a recording unit, having an optical axis, and displayed in a display unit. A data processing unit is then used to generate a virtual object to be inserted and display it on the display unit or overlay it on the real object. With at least two light-sensitive sensors, each having a known sensor directivity pattern, a sensor positioning and a sensor alignment, an illumination is then detected and output in each instance as sensor output signals. Using these sensor output signals and based on the known sensor positioning, the sensor alignment and the characteristics of the sensor directivity pattern, an illumination angle is then determined in relation to the optical axis and light guidance or the insertion of virtual shadow and/or fill-in regions is then carried out for the virtual object as a function of the determined illumination angle.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a simplified diagram of a method and the associated device for carrying out light guidance in an augmented reality system in accordance with one potential embodiment of the present invention;

FIG. 2 shows a simplified diagram of the device according to FIG. 1 to illustrate the mode of operation of the sensor directivity patterns of the sensors during determination of an illumination angle;

FIG. 3 shows a simplified diagram to illustrate the one-dimensional illumination angle determined in an augmented reality system; and

FIG. 4 shows a simplified diagram to illustrate a spatial illumination angle by two one-dimensional illumination angles.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

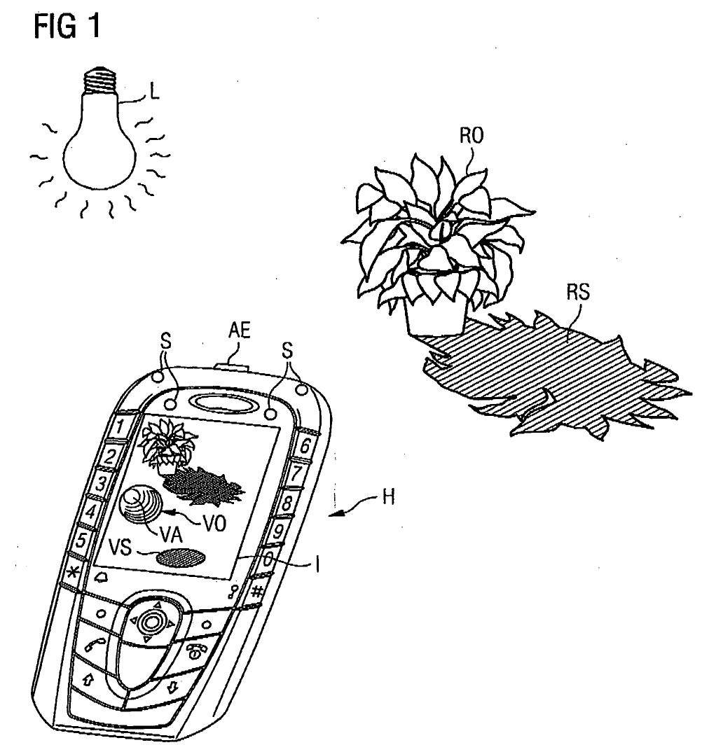

FIG. 1 shows a simplified diagram of an augmented reality system, as can be implemented for example in a mobile terminal and in particular a mobile telecommunication terminal or mobile telephone H.

According to FIG. 1 an image of a real environment or a real object to be recorded RO with an associated real shadow RS is recorded by a camera or recording unit AE integrated in the mobile terminal H and displayed on a display unit 1. To augment the recorded image, a ball for example is overlaid as what is known as a virtual object VO on the recorded real object with its associated shadow, which can be a flowerpot for example, resulting in an augmented reality. The real object RO with its associated real shadow RS and the virtual object VO can of course also be any other objects.

FIG. 1 also shows a light source L, for example in the form of an incandescent lamp, which, as the main light source, is primarily responsible for illuminating the real environment or real object RO and thus generates the real shadow or shadow region RS associated with the real object RO. As such a real shadow RS also changes correspondingly as the illumination conditions change, for example shortening or lengthening or being rotated through a predetermined angle, such illumination conditions must also be taken into account for what is known as light guidance for the virtual object VO. More specifically, not only is the virtual object VO added to the real environment displayed on the display unit I but a corresponding virtual light guidance is also carried out, in other words for example a virtual shadow VS of the virtual object VO and/or a virtual fill-in region VA on the virtual object VO is added as a function of the respective illumination conditions. This produces very realistic representations with augmented reality.

To realize such light guidance, in contrast to the related art, shadow objects or what are known as shadow catchers inserted into the scene are not used, rather an illumination angle is determined in relation to an optical axis of the recording unit AE by at least two light-sensitive sensors S, which are located for example on the surface of a housing of the mobile terminal H. The light-sensitive sensors S here each have a known sensor directivity pattern with a known sensor alignment and a known sensor positioning. Based on this sensor positioning, the sensor alignment and the characteristics of the sensor directivity pattern, it is then possible to evaluate the sensor output signals output at the respective sensors or their amplitude values, such that an illumination angle can be determined in relation to the optical axis of the recording unit AE, as a result of which virtual light guidance can in turn be carried out in the image on the display unit I for the virtual object or a virtual shadow region VS and/or a virtual fill-in region VA can be generated. This calculation is for example processed by a data processing unit present in any case in the mobile telecommunication terminal H, said data processing unit also being responsible for example for setting up and canceling connections and a plurality of further functionalities of the mobile terminal H.

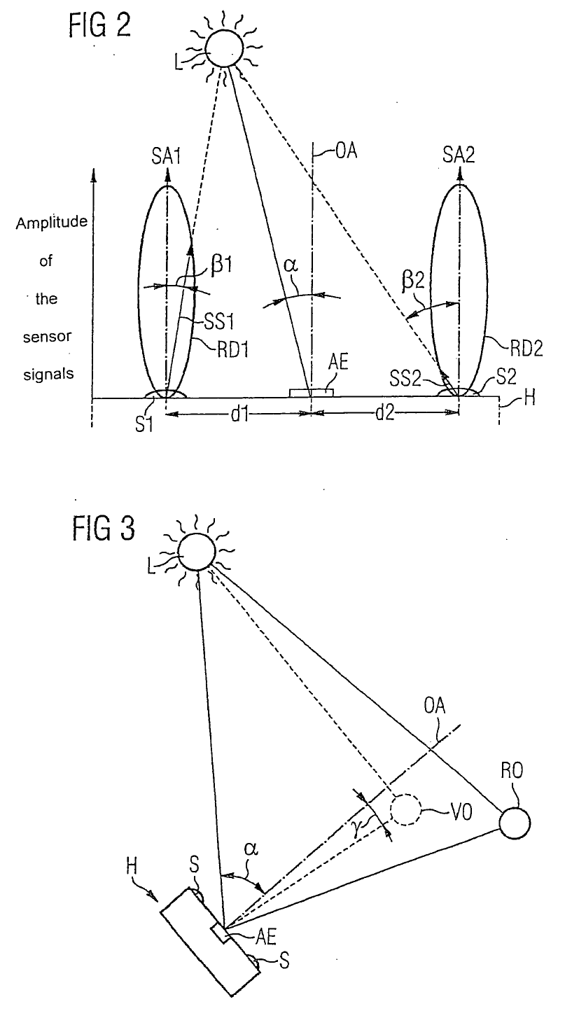

FIG. 2 shows a simplified diagram to illustrate the basic mode of operation during the determination of an illumination angle, as required for the light guidance or the generation of virtual shadow and virtual fill-in regions.

According to FIG. 2 the recording unit AE or a known camera and at least two light-sensitive sensors S1 and S2 are disposed on the surface of the housing of the mobile terminal H. The recording unit AE has an optical axis OA, which is defined below as the reference axis for the illumination angle a to be determined in relation to a light source L.

To simplify the diagram, according to FIG. 2 only one one-dimensional illumination angle a is first considered and detected within one plane between a light source L and the optical axis OA of the recording unit. FIG. 2 also only shows a single light source L, which is realized for example by the sun in the case of a daylight environment.

The sensors S1 and S2 have a known sensor positioning in respect of the recording unit AE and are located at a known distance d1 and d2 from the recording unit AE in FIG. 2. The sensors S1 and S2 also have a known sensor alignment SA1 and SA2 in relation to the optical axis OA of the recording unit, which is correlated to a respective known directivity pattern RD1 and RD2. The sensor alignment SA1 and SA2 is parallel to the optical axis OA of the recording unit according to FIG. 2, resulting in simplified calculation of the one-dimensional illumination angle α. According to FIG. 2 the curve of the directivity pattern RD1 and RD2 is elliptic, having an elliptic club shape in a spatial representation.

The mode of operation of the sensor directivity pattern is as follows here: a distance from the sensor to the edge of the elliptic curve or spatial elliptic club shape of the sensor directivity pattern corresponds to an amplitude of a sensor output signal SS1 and SS2, output at the sensor, when light from the light source L strikes the sensors S1 and S2 at a corresponding angle β1 or β2 to the sensor alignment SA1 or SA2. An amplitude of the sensor output signal SS1 and SS2 is therefore a direct measure of the angles β1 and β2, so a one-dimensional illumination angle α can be determined uniquely with knowledge of the characteristics of the directivity pattern RD1 and RD2 or the curve shapes and sensor positionings or distances d1 and d2, as well as the sensor alignment SA1 and SA2 in relation to the optical axis OA.

According to FIG. 3 it is possible as a function of this one-dimensional illumination angle a, between the optical axis OA of the recording unit AE and the virtual object to be inserted, and a known virtual angle γ to carry out the corresponding virtual light guidance and to insert a virtual shadow region VS and/or a virtual fill-in region VA for example in the image on the display unit I according to FIG. 1, in a manner that is both realistic and accurate in respect of angles.

The light-sensitive sensors S or S1 and S2 can for example be realized in the form of a photodiode, a phototransistor or other photo-sensitive elements, having a known directivity pattern. A directivity pattern can also be set or adjusted correspondingly by way of a lens arrangement, which is located in front of the light-sensitive sensor. Taking into account the sensor directivity patterns RD1 and RD2 and the associated sensor alignments SA1 and SA2 it is then possible to determine the resulting one-dimensional light-incidence angle or illumination angle α in one plane, which is defined through the two sensor elements S1 and S2, by establishing the relationship between the two sensor output signals SS1 and SS2, as in the monopulse method used in radar technology.

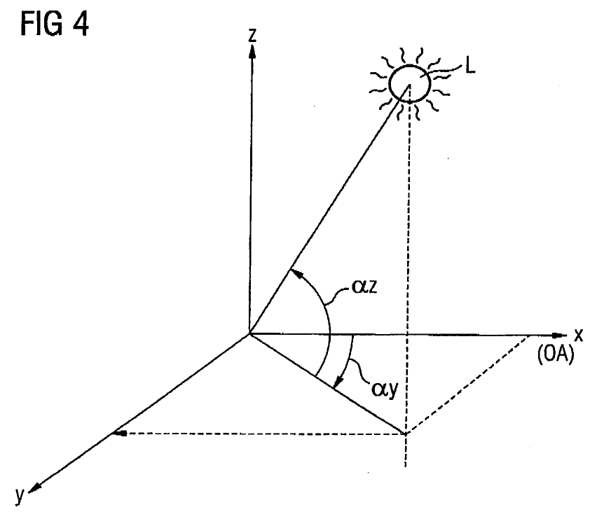

Since only one one-dimensional illumination angle a can be determined with two such light-sensitive sensors but a spatial illumination angle has to be determined for realistic light guidance, two such one-dimensional illumination angles are determined in an exemplary embodiment according to FIG. 4, to determine a spatial illumination angle.

More specifically, in FIG. 4 two such arrangements as shown in FIGS. 2 and 3 are combined, so that respective one-dimensional illumination angles ay can be determined for example in a y direction and α_{z} in a z direction. A resulting spatial illumination angle can thus be determined for a light source L in the space.

A third light-sensitive sensor is preferably disposed here on the surface of the housing of the mobile terminal H for example, such that it is located in a further plane. In the simplest instance it is disposed according to FIG. 4 for example perpendicular to the x-y plane of the first two sensors in an x-z or y-z plane, giving a rectangular coordinate system. One of the three sensors is hereby preferably used twice to determine the two one-dimensional illumination angles α_{y} and α_{z}. In principle however other sensor arrangements and in particular a larger number of sensors are possible, allowing further improvement of the accuracy or a detection region of the illumination conditions. The respective sensor alignments, sensor positionings and sensor directivity patterns are taken into account when evaluating the output sensor output signals.

A standard method for determining the spatial illumination angle from two one-dimensional illumination angles is the triangulation method known from GPS (global positioning system) systems for example. However any other methods can also be used to determine a spatial illumination angle.

According to a second exemplary embodiment (not shown), such a spatial illumination angle can however also be determined or estimated based on only one one-dimensional illumination angle, if the plane of the two light-sensitive sensors required for this one-dimensional illumination angle is parallel to a horizon or earth surface and the main illumination source is realized by the sun or sunlight, as is generally the case for example with a daylight environment.

According to this particular exemplary embodiment, a time of day at a defined location, from which a position of the sun or a second illumination angle perpendicular or vertical to the earth surface can be estimated, is also taken into account in addition to a one-dimensional illumination angle, to determine the spatial illumination angle. As a result only illumination changes taking place in a horizontal direction are detected by the two sensors S1 and S2 or by the one-dimensional illumination angle α, while the illumination changes taking place in a vertical direction are derived from a current time of day.

For this purpose a timer unit is used, which is generally present in any case in mobile terminals H, for example in the form of a clock with time zone data and summer-time is taken into account. A detection unit to detect a color temperature of the illumination present can also be provided to determine a daylight or artificial light environment, with an analysis unit analyzing or evaluating the detected color temperature. Since the known recording units or cameras deployed in mobile terminals H generally provide such information in respect of a color temperature in any case, the recording unit AE is used as the detection unit for color temperature and the data processing unit of the mobile terminal H is used for the analysis unit. The use of timer units and recording units that are present in any case results in a particularly simple and economical realization for this second exemplary embodiment.

Such embodiments can of course also be combined with further sensors to determine further one-dimensional illumination angles, ultimately resulting in a spatial illumination angle, on the basis of which virtual light guidance can be carried out or the virtual shadow and/or virtual fill-in regions can be generated for the virtual objects. It is possible to improve accuracy as required using this technique.

To simplify calculations further and to increase the accuracy of the calculation results, the characteristics or curves according to FIG. 2 of the sensor directivity patterns of the sensors S used are preferably the same or identical and the distances between the sensors are as large as possible.

To realize the most realistic light guidance possible, the illumination angle is carried out continuously in respect of time as a function of the recording unit AE. More specifically, associated calculations and corresponding light guidance are carried out for example for each recording of an image sequence. In principle however such calculations can also be restricted just to predetermined time intervals, which are independent of the functionality of the recording unit, in particular to save resources, such as computing capacity for example.

To realize the most flexible method possible and an associated device for light guidance in an augmented reality system, the sensors with their known sensor alignments and associated sensor directivity patterns can also be disposed in a rotatable manner, for example on the surface of the housing of the mobile terminal H, with the changing angle values for the sensor alignments however also having to be detected and transmitted to the data processing unit to be compensated for or taken into account.

Finally a threshold value decision unit can also be provided to determine a uniqueness of an illumination angle and therefore the illumination conditions, with the virtual light guidance for the virtual objects being disabled or no virtual shadow and/or virtual fill-in regions being generated in the image on the display unit in the absence of uniqueness. Incorrect virtual light guidance can therefore be prevented in particular in very diffuse light conditions or where there are a plurality of equivalent light sources disposed in the space, with the result that virtual objects can be displayed in a very realistic manner.

The device and method were described on the basis of a mobile telecommunication terminal, such as a mobile telephone H for example. It is however not restricted thereto and equally covers other mobile terminals, such as PDAs (personal digital assistants). It can also be used on stationary augmented reality systems. The device and method were also described on the basis of a single light source, such as an incandescent bulb or a sun. The device and method are however not restricted thereto but equally covers other main light sources, which can be made up of a plurality of light sources or different types of light sources. The device and method were also described on the basis of two or three light-sensitive sensors to determine an illumination angle. It is however not restricted thereto but equally also covers systems with a plurality of light-sensitive sensors, which can be positioned and aligned in any manner in relation to the recording unit AE and its optical axis OA.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-22. (canceled)

23. A device for light guidance in an augmented reality system, comprising:
a recording unit, having an optical axis, to record a real object;
a display unit to display the real object and a virtual object after the real object has been recorded by the recording unit;
at least two light-sensitive sensors, each with a known sensor directivity pattern and having a known sensor positioning and sensor alignment with respect to the optical axis of the recording unit, the sensors each producing a detected sensor output signal; and
a data processing unit to determine an illumination angle in relation to the optical axis of the recording unit based on the known sensor positioning, the known sensor alignment, the known sensor directivity pattern and the sensor output signals, the data processing unit guiding light for the virtual object as a function of the illumination angle.

24. The device as claimed in claim 23, wherein while light is being guided, a virtual shadow and/or a virtual fill-in region for the virtual object is inserted on an image of the virtual object on the display unit.

25. The device as claimed in one of claim 23, wherein a one-dimensional illumination angle is determined by establishing a relationship between two sensor output signals taking into account the respective sensor directivity.

26. The device as claimed in claim 25, wherein a spatial illumination angle is determined by triangulating two one-dimensional illumination angles.

27. The device as claimed in one of claim 23, further comprising:
a detection unit to detect a color temperature of light used to illuminate the real object, and
an analysis unit to analyze the color temperature and to determine whether the light is daylight or artificial light environment.

28. The device as claimed in claim 27, wherein the detection unit is part of the recording unit and the analysis unit is part of the data processing unit.

29. The device as claimed in one of claim 25, further comprising a timer unit to output a time of day, with a spatial illumination angle being determined based on the one-dimensional illumination angle and the time of day.

30. The device as claimed in one of claim 23, wherein the light-sensitive sensors have the same directivity pattern.

31. The device as claimed in claim 23, wherein the light-sensitive sensors are positioned at opposite ends of a field, with a distance between the light-sensitive sensors being as large as possible.

32. The device as claimed in claim 23, wherein the illumination angle is determined continuously as a temporal function of the recording unit.

33. The device as claimed in one of claim 23, wherein the light-sensitive sensors are rotatable.

34. The device as claimed in claim 23, further comprising a threshold value decision unit to determine whether the illumination angle is unique, the light for the virtual object not being guided unless the illumination angle is unique.

35. A method for light guidance in an augmented reality system, comprising:
recording a real object using a recording unit having an optical axis;
displaying the recorded real object on a display unit;
generating a virtual object using a data processing unit;
displaying the virtual object on the display unit;
detecting actual illumination using at least two light-sensitive sensors, each having a known sensor directivity pattern, a known sensor positioning and a known sensor alignment, the sensors each producing a sensor output signal;
determining an illumination angle of the actual illumination in relation to the optical axis of the recording unit, the illumination angle being determined using the sensor output signals the known sensor positioning, the known sensor alignment and the known sensor directivity patterns; and
carrying out]guiding virtual light for the virtual object as a function of the illumination angle.

36. The method as claimed in claim 35, wherein while light is being guided, a virtual shadow and/or a virtual fill-in region for the virtual object is inserted on an image of the virtual object on the display unit.

37. The method as claimed in claim 35, wherein a one-dimensional illumination angle is determined by establishing a relationship between two sensor output signals.

38. The method as claimed in claim 37, wherein in step a spatial illumination angle is determined by triangulating two one-dimensional illumination angles.

39. The method as claimed in claim 35, further comprising detecting a color temperature of the actual illumination to determine whether the actual illumination is daylight or artificial light.

40. The method as claimed in claim 39, wherein the color temperature is detected by the recording unit.

41. The method as claimed in claim 39 wherein a time of day is, and
when the actual illumination is determined to be daylight, a spatial illumination angle is determined based on a one-dimensional illumination angle and the time of day.

42. The method as claimed in claim 35, wherein the light-sensitive sensors are positioned at opposite ends of a field, with a distance between the light-sensitive sensors being as large as possible.

43. The method as claimed in claim 35, wherein the illumination angle is determined continuously as a temporal function of the recording unit.

44. The method as claimed in claim 35, wherein the light-sensitive sensors are rotatable.
